(19) United States
(12) Patent Application Publication
(10) Pub. No.: US 2007/0215062 A1
(43) Pub. Date: Sep. 20, 2007

(54) Cat pouch-bed

(76) Inventor: Bruce D. Cummings, Eden Prairie, MN (US)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/725,089

(22) Filed: Mar. 16, 2007

Related U.S. Application Data
(60) Provisional application No. 60/784,063, filed on Mar. 17, 2006.

(51) Int. Cl. A01K 15/02

(52) U.S. Cl. 119/706

(57) ABSTRACT

A cat-pouch bed includes a top layer which may be at least partially elevated relative to a bottom layer to form an internal cavity for a pet. One or more supports may be disposed between the top layer and the bottom layer to maintain at least a portion of the top layer above the bottom layer in a variety of configurations. The top layer and bottom layer may be formed of foam and enclosed within fabric material.

### CROSS-REFERENCE TO RELATED APPLICATIONS

This application claims the benefit of U.S. Provisional Patent Application No. 60/784,063, filed Mar. 17, 2006, the entire contents of which are incorporated herein by reference in its entirety.

### BACKGROUND OF THE INVENTION

Pets, particularly felines, are curious and playful. Felines frequently explore inaccessible or hidden spaces under furniture or in corners of structures. Felines also occasionally prefer to sleep and recreate within dark spaces, which are similar to a burrow or a cave. In addition, pets prefer to sleep and rest upon soft cushions or beds. The beds/cushions for pets, particularly felines as known, generally restrict the location where the animal may sleep to the top surface of a bed or cushion. No pet device is known which enables a feline to explore, play, and/or sleep within the interior of a soft cushion or bed.

A need therefore exists for a pet device which is soft, and which may be manipulated by an individual or a pet to form a pouch, where a pet may play or rest.

Pet beds as known are covered by a variety of fabrics which may be stuffed with a variety of substances. Some of the pet beds as known are difficult to clean and wash due to the burdensome task of removing the bedding substance from the interior of the fabric cover. A need exists for a feline bed which improves the ease of separation of a bedding substance from a fabric cover during cleaning activities. A need also therefore exists for a feline bed which is easily cleaned by simultaneously washing both bed and cover.

Pet beds as known also do not provide flexibility to an individual to periodically alter or modify the structure of the bed, to meet a particular interest of a family pet. No pet beds are known which may be easily disassembled and reassembled in a different configuration for use by a feline.

Without limiting the scope of the invention a brief summary of some of the claimed embodiments of the invention is set forth below. Additional details of the summarized embodiments of the invention and/or additional embodiments of the invention may be found in the Detailed Description of the Invention below.

### BRIEF SUMMARY OF THE INVENTION

The cat pouch-bed 10 is formed of a soft material preferably foam having a top layer and a bottom layer. The top layer may be independent of the bottom layer and may include a front edge, a rear edge, and opposite side edges. The bottom layer may also include a first front edge, a second side edge, a third side edge, and a fourth rear edge. The first front edge is adapted to be positioned proximate to the front edge. The fourth rear edge is preferably disposed proximate to the rear edge. The second side edge and the third side edge may be partially, and releasably engaged to one of the opposite side edges.

The front edge of the top layer may be elevated from the first front edge of the bottom layer to raise a portion of the top layer relative to the bottom layer, thereby creating a cavity or pouch between the top and bottom layers. Each of the top and bottom layers may be formed of foam which may be washable. The top and bottom layers may also be enclosed within a fabric material which may be washable. The edges of the fabric material may include a number of different types of fastening mechanisms and/or devices to releasably secure at least a portion of the second side edge and the third side edge to the opposite side edges.

The cat pouch-bed may also include one or more first supports; second supports; first side supports; second side supports; intermediate supports; and traverse supports. The first support is preferably positioned proximate to the front edge of the top layer and the second support is preferably positioned proximate to the rear edge of the top layer. The first and second supports alternatively may cross relative to each other when elevating at least a portion of the top layer above the bottom layer. The first support, second support, first side support, second side support, traverse support, and intermediate supports may be flexible or pliable and adapted for releasable engagement to each other. The first, second, first side, second side, intermediate and traverse supports may also be releasably coupled to each other to create a variety of configurations for elevation of portions of the top layer from the bottom layer. The first, second, first side, second side, intermediate, and traverse supports are also not required to be equal in length, and may have any dimension as desired by an individual.

The first, second, first side, second side, intermediate, and traverse supports may also be releasably engaged to the interior of the top layer by a variety of devices including, but not limited to, positioning loops or sleeves, the use of pockets, straps, and/or hook and loop fabric material.

These and other aspects, embodiments and advantages of the present invention will be apparent to those of ordinary skill in the art upon review of the Detailed Description and Claims to follow.

### BRIEF DESCRIPTION OF THE SEVERAL VIEWS OF THE DRAWING(S)

FIG. 1A is a detail perspective view of a support frame.

FIG. 1B is an alternative detail perspective view of a support frame.

FIG. 1C is an alternative detail perspective view of a support frame.

FIG. 1D is an alternative detail perspective view of a support frame.

FIG. 1E is an alternative detail perspective view of a support frame.

FIG. 1F is an alternative detail perspective view of a support frame.

FIG. 1G is an alternative detail perspective view of a support frame.

FIG. 1H is an alternative detail perspective view of a support frame

FIG. 2 is a perspective view of the cat pouch-bed.

FIG. 3 is an alternative perspective view of the cat pouch-bed.

FIG. 4 is a front view of the cat pouch-bed.

FIG. 5 is an alternative view of the cat pouch-bed.

FIG. 6 is an alternative view of the cat pouch-bed.

FIG. 7 is an alternative detail perspective view of a support frame.

FIG. 8 is an alternative detail perspective view of a support frame.

FIG. 9 is an environmental view of the cat pouch-bed.

FIG. 10 is a detail view of a fastening element.

FIG. 11 is an alternative detail view of a fastening element.

FIG. 12 is an alternative detail view of a fastening element.

FIG. 13 is an alternative detail view of a fastening element.

FIG. 14 is an alternative detail view of a fastening element.

FIG. 15 is an alternative isometric view of the cat pouch-bed.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

The cat pouch-bed 10 is illustrated and described herein. The cat pouch-bed 10 in general is formed an open or closed cell foam top layer 12 as engaged to an open or closed cell foam bottom layer 14. The top layer 12 and bottom layer 14 may be formed of convoluted or other types of foam material. Each of the top layer 12 and bottom layer 14 are preferably enclosed within, or are covered by, fabric material 16 which may be faux fur, polyester, or any other fabric material which is not susceptible to tearing when exposed to feline claws. In addition, the material of the cover 16 for the top layer 12 and bottom layer 14 is preferably selected to deter a cat from chewing or eating the fabric cover 16. In addition, the fabric material 16, as well as the top layer 12 and bottom layer 14, are preferably machine washable.

In general, the shape of the top layer 12 and bottom layer 14 may be square, rectangular, oval, or any other geometric shape as desired by an individual. The cat pouch-bed 10 preferably has a front 18, back 20, and opposite sides 22. The front 18 of the cat pouch-bed 10 is preferably open 24, where the opposite sides 22 and back 20 of the cat pouch-bed 10 may be at least partially engaged together through the use of permanent and/or releasable affixation means 26. The affixation means 26 may include, but are not necessarily limited to, sewing, hook and loop fasteners, zippers, buttons, snaps, buckles, fabric folds, and/or any other fastening means as used by individuals.

In alternative embodiments, the cat pouch-bed 10 may include an open front 24 and an open rear 28 which are shaped to appear as a half tube. (FIG. 15) In this embodiment, the opposite sides 22 of the cat pouch-bed 10 are at least partially fixed together through the use of any one or more of the affixation devices as earlier identified.

The cat pouch-bed 10 may include a support generally referred to by the numeral 30 as integral to the front edge 32 of the top layer 12 and/or front edge 34 of the bottom layer 14. The front edge 32 of the top layer 12 and/or the front edge 34 of the bottom layer 14 may include pockets, loops, straps, hook and loop fasteners, sleeves, and/or any other device to permanently or releasably receive and secure a pliable support member 36. The pliable support member 36 may be interior or exterior to the fabric cover 16 for the top layer 12 and bottom layer 14. The flexible support member 36 preferably provides an arcuate shape for the front end or open end 24 of the top layer 12, to provide access into the interior of the cat pouch-bed 10 by a family pet. In general, the flexible support member 36 may function as a bridge for the top layer 12, for separation from the bottom layer 14, to provide access into the interior of the cat pouch-bed 10.

The interior of the cat pouch-bed 10 may include hook and loop fasteners 60, support pockets 62, guides 64, sleeves 66, straps 68, and/or any other type of mechanical device to either permanently or releasably engage the support member 36 for retaining the cat pouch-bed 10 in an open configuration. Generally the top layer 12 is separated from the bottom layer 14 proximate to the front 24 of the cat pouch-bed 10.

The supports as used in the cat pouch-bed 10 may be metallic, plastic, fiberglass, and/or any other material for adjustable elevation of the front 32 of the top layer 12 from the front 34 of the bottom layer 14.

In an alternative embodiment, the cat pouch-bed 10 may not include a support 30 which enables a feline to sleep and/or play on the upper surface of the top layer 12. In this embodiment, the top layer 12 is disposed immediately adjacent to, and above the bottom layer 14. A feline may sleep or play on the top of the two adjacent convoluted foam layers as encased within a desired type and/or design of fabric 16. Alternatively, a feline may separate the top layer 12 from the bottom layer 14 for access to the interior of the cat pouch-bed 10, where no independent resilient support 30 is provided, the pet may retain the front edge 32 above the front edge 34 of the bottom layer 14 when the feline is between the adjacent top and bottom layers.

In at least one embodiment, the top layer 12 and the bottom layer 14 are each enclosed within a fabric cover 16 which may secure and encase the respective top layer 12 and bottom layer 14 in a closed configuration through the use of hook and loop material, snaps, straps, buttons, fabric folds, buckles, zippers, and/or any other fastening device. The foam top layer 12 and/or foam bottom layer 14 may be removable from the interior of the fabric covering 16 for washing and/or cleaning. In this embodiment, mechanical means 26 such as a zipper, buttons, hook and loop fabric material, snaps, straps, buckles, and/or any other fastening means may additionally be utilized to attach the rear edge 38 of the top layer 12 to the rear edge 40 of the bottom layer 14. Alternatively, the opposite sides 22 of the cat pouch-bed 10 may include mating sections of a zipper, hook and loop fabric material, straps, snaps, buttons, folds, buckles, etc., to releasably secure the opposite sides 22 of the cat pouch-bed 10 together. The fabric material 16 encasing the top layer 12 and the bottom layer 14 may alternatively each include an opening proximal to one of the opposite sides 22 for withdrawal of the foam material from the interior of the fabric casing 16. Upon removal of the foam layer from the fabric casing 16, the fabric casing and/or the foam may be cleaned through conventional washing procedures.

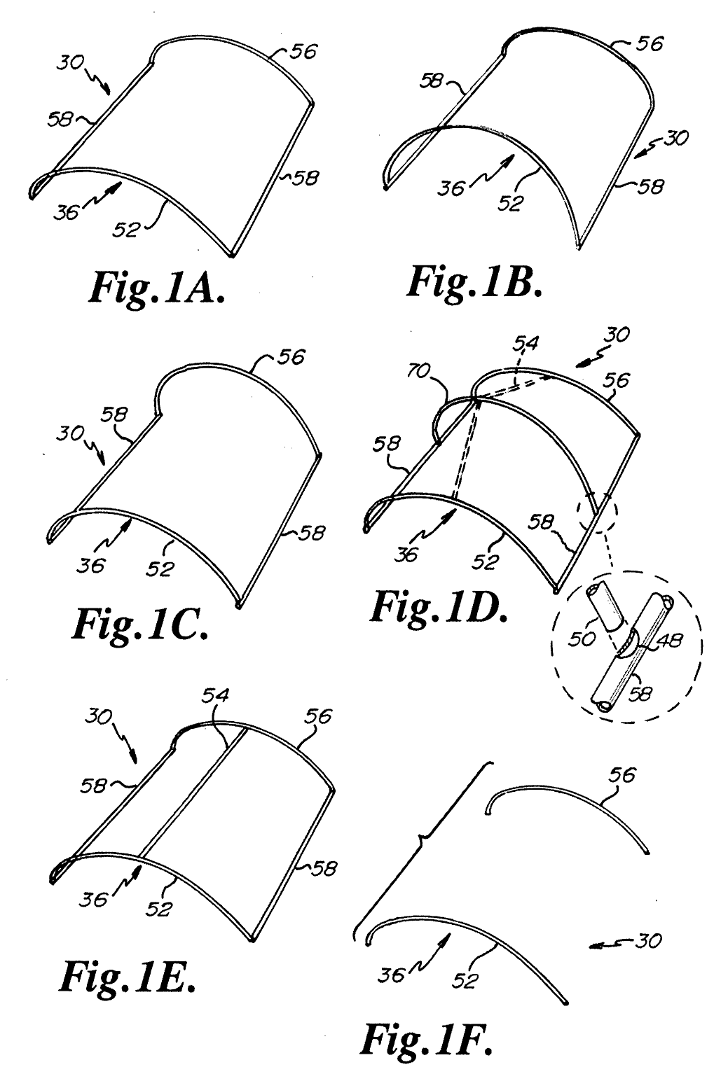

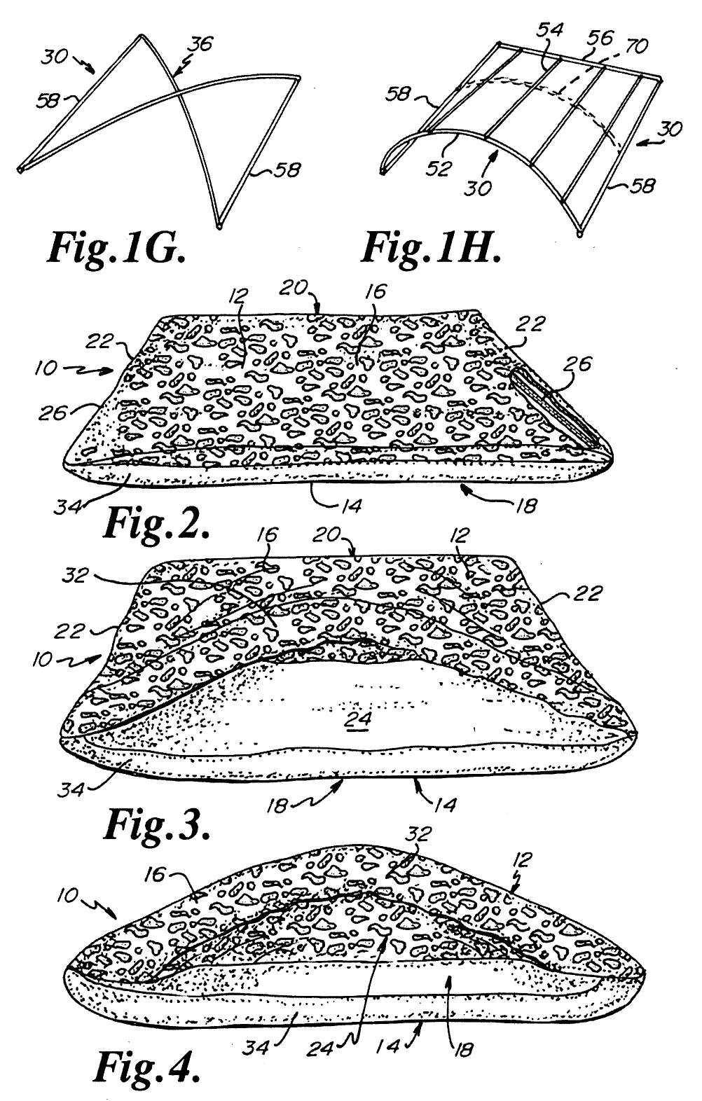

In one embodiment, one or more supports 36 may be utilized to retain either the front 18 and/or back 20 of the cat pouch-bed 10 in an open 24 configuration to provide access to a feline. The supports 36 may be disposed in a longitudinal or horizontal direction, or in a perpendicular direction relative to the front 18 and/or back 20 of the cat pouch-bed 10. The supports 36 may function as bridges to elevate a portion of the top layer 12 from the bottom layer 14. It should be noted that the supports 36 may be assembled in any number of configurations as desired to provide an open space within the interior of the cat pouch-bed 10 for a feline. (Generally see FIGS. 1A-1H)

In at least one embodiment, cat nip and/or cat toys 44 may be releasably secured to the supports 36 for dangling within the interior of the cat pouch-bed 10. In alternative embodiments, cat nip and/or cat toys 44 maybe releasably or permanently secured to the interior surface of the cat pouch-bed 10 for flush or dangling engagement thereto, to provide recreation for a feline.

In at least one embodiment, a ring or washer 46 may be used to slidably engage two or more supports 36 together in a crossing relationship to each other, for use in the elevation of at least a portion of the top layer 12 above the bottom layer 14. The supports 36 may be wire, plastic supports, and/or any other material as desired by an individual.

In at least one embodiment, any cat toy or cat nip 44 may be slidably repositioned along a bridge or support 36 within the interior of the cat pouch-bed 10. It should be noted that one or more different types of items may be releasably or permanently secured to the interior of the cat pouch-bed 10 or the supports 36 as desired.

In some embodiments, individual supports 36 may include one or more openings 48 for receiving engagement of the ends 50 of other support elements 36. In at least one embodiment a bridge may be formed of one or more supports 36. Preferably, each support 36 is resiliently pliable for use in elevation of the top layer 12 above the bottom layer 14.

In at least one embodiment, the supports 36 are not required to be of the same dimension. For example, the dimensions for the front support 52 may be larger than the back support 56, so that the front opening 24 is increased in dimension as compared to the elevation of the rear edge 38 of the top layer 12, with respect to the rear edge 40 of the bottom layer 14. For example, please see FIG. 1B showing a support having an increased arcuate dimension proximate to the front edge 32 and a reduced arcuate dimension proximate to the rear edge 38 of the top layer 12.

In an alternative embodiment, please see FIG. 1H where the rear edge 38 of the top layer 12 and the rear edge 40 of the bottom layer 14 may be either permanently or releasably engaged to each other, and where the top layer 12 is provided with a front opening 24. In this embodiment, the front support 52 is arcuate, and the support 56 proximate to the rear edge 38 is not arcuate or is substantially horizontal. Intermediate supports 54 may extend between the arcuate front support 52 and the rear support 56 to elevate at least a portion of the top layer 12 relative to the bottom layer 14 in a descending relationship, for definition of the interior of the cat pouch-bed 10.

It should be noted that any of the supports 36 as depicted within FIGS. 1A through 1H and FIGS. 7 and 8 may be combined for the provision of a type and shape of interior cavity for the cat pouch-bed 10 as identified herein. Each support 36 may include one or more apertures or holes 48 for receiving engagement of other supports 36, to create a frame assembly for positioning within the interior of the cat pouch-bed 10. In at least one embodiment, any traverse 70 or intermediate 54 frame support may be disassembled from other frame supports 36 to facilitate transportation and reassembly at the discretion of an individual. In at least one embodiment, a frame of assembled supports 36 does not roll or tip over and is of sufficient strength and durability to support a feline standing upon the upper surface of the top layer 12.

In some embodiments, the frame supports 36 may be coated with a fabric 16 or other material.

The interior of the cat pouch-bed 10 may include one or more sets of hook and loop fasteners 60, pockets 62, loops, guides 64, sleeves 66, straps 68, tubes, and/or openings for receiving engagement of individual supports 36. In an alternative embodiment, the resilient supports 36 may be positioned within the interior of the fabric 16 proximate to the foam, the front edge 32, back edge 38, and side edges 22, or may traverse the foam top layer 12 in any desired direction. In alternative embodiments, the supports 36 may be positioned immediately below the foam within the interior of the fabric 16 covering.

As seen in FIG. 1A, a frame support is provided having two side frame supports 58 and two equally sized and shaped arcuate front 52 and rear supports 56. In FIG. 1B a frame support is depicted having two parallel side frame supports 58, a front 52 arcuate support having an increased dimension relative to a rear 56 arcuate support.

In FIG. 1C, a frame support is depicted having two parallel side frame supports 58, a front 52 frame support having a reduced dimension as compared to a rear 56 frame support. FIG. 1D depicts a frame support system having two parallel side frame supports 58 and a traverse frame supports 70. In addition, as depicted in FIG. 1D in phantom line, a supplemental perpendicular intermediate frame support 54 may extend between the front 52 and rear 56 frame supports.

As depicted in FIG. 1E, a frame support system is disclosed having two parallel side frame supports 58, a front 52 and rear 56 arcuate frame support, and a perpendicular intermediate frame support 54 extending between the front 52 and rear 56 frame supports. FIG. 1F depicts two independent arcuate frame supports for positioning proximate to the front 52 and rear 56 of the cat pouch-bed 10.

FIG. 1G depicts two arcuate frame supports 36 which are affixed together through the two parallel side frame supports 58. FIG. 1H depicts a frame support system having parallel opposite side frame supports 58, a front 52 arcuate frame support, a rear 56 straight frame support, and a plurality of perpendicular intermediate frame supports 54 extending from the arcuate front frame 52 support downwardly to the rear 56 horizontal frame support. In phantom line is shown a traverse frame support 70 as engaged to the opposite side frame supports 58 and the perpendicular intermediate frame supports 54.

FIG. 2 depicts the cat pouch-bed 10 within a first unopened position where the top layer 12 is proximate to the bottom layer 14. The side 22 and back edges 38, 40 for the cat pouch-bed 10 may be either permanently or releasably secured together. The front edge between the top layer 12 and bottom layer 14 are preferably not affixed together in order to provide access within the interior of the cat pouch-bed 10.

FIG. 3 shows the cat pouch-bed 10 of FIG. 2 with the top layer 12 elevated with respect to the bottom layer 14. As depicted in FIG. 3, the front edge 32 of the top layer 12 may include a support 52 as interior to the fabric cover 16 to facilitate the retention of the front edge 32 of the top layer 12 elevated above the bottom layer 14.

In an alternative embodiment, the front edge 32 of the top layer 12 is not required to include any support.

FIG. 4 shows an alternative embodiment of the cat pouch-bed 10 having the front edge 32 of the top layer 12 elevated relative to the bottom layer 14.

FIG. 5 shows an alternative embodiment where the bottom layer 14 is separated and/or elevated relative to the top layer 12. In this embodiment, the cat pouch-bed 10 has been flipped 180° whereupon the top layer 12 functions as a bottom layer 14 and the bottom layer 14 functions as the top layer 12.

As depicted within FIG. 6, one or more items 44 maybe permanently or releasably secured to the interior of the top layer 12 to provide recreation to a feline. In FIG. 6, a bag 44 is disclosed which may be filled with catnip and/or other items at the discretion of an individual.

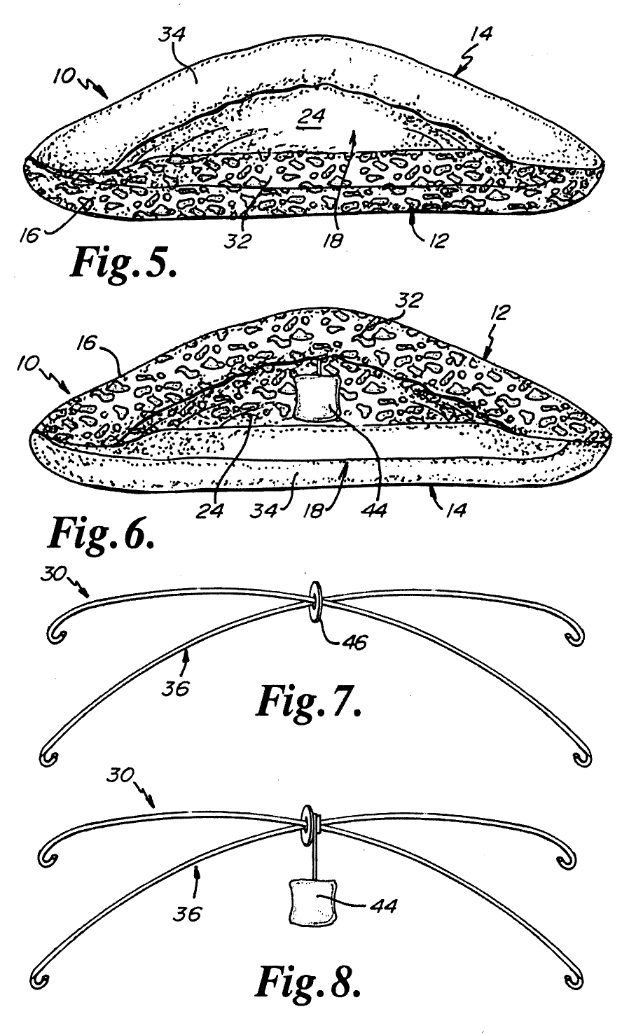

As depicted in FIG. 7, a frame support is identified having arcuate frame elements 36 engaged together through the use of a washer 46. It should be noted that the washer 46 may be slidable relative to the frame supports 36 to provide a desired orientation for the supports 36.

As depicted in FIG. 8, an item such as a pouch of catnip 44 may be releasably or permanently secured to one or more of the frame supports 36 for positioning within the interior of the cat pouch-bed 10.

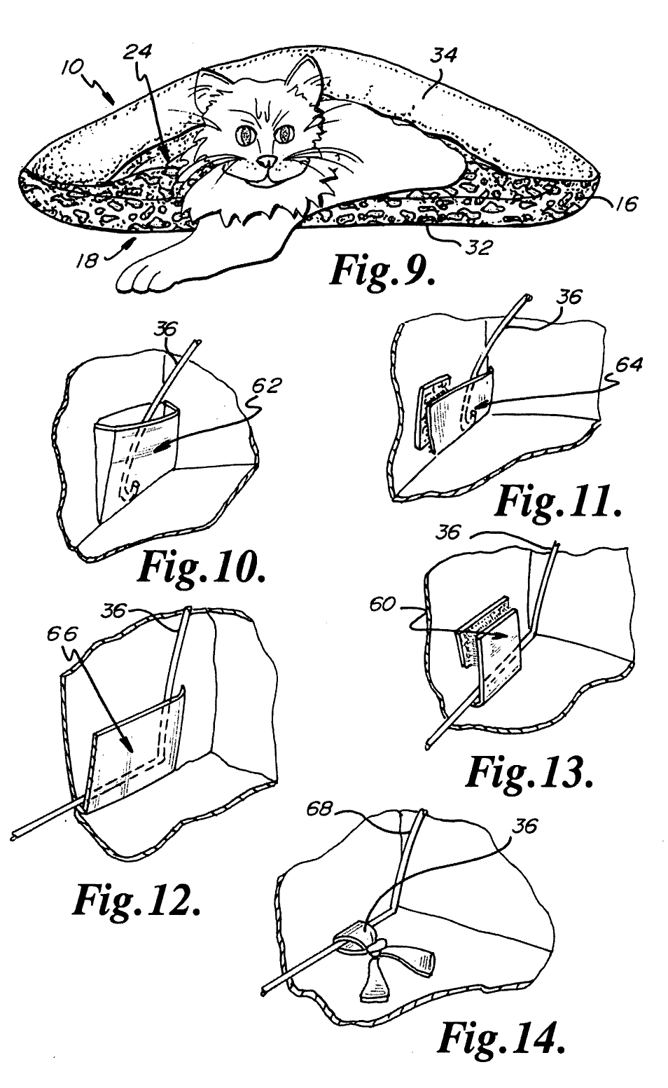

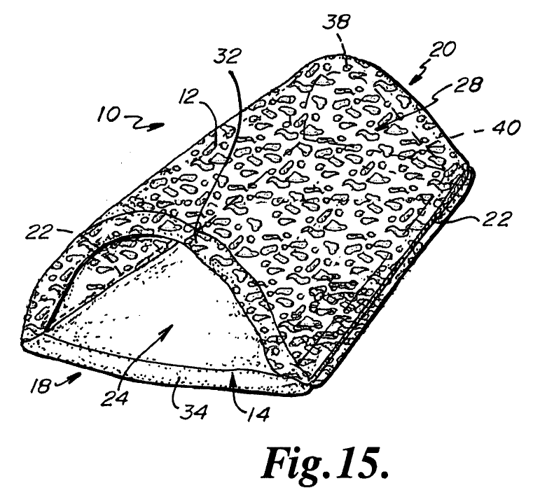

FIG. 9 shows a feline within the interior of the cat pouch-bed 10 as described herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims.

This completes the description of the preferred and alternate embodiments of the invention. Those skilled in the art may recognize other equivalents to the specific embodiment described herein which equivalents are intended to be encompassed by the claims attached hereto.

1. A pet device comprising:
a) a top layer comprising foam, said top layer further comprising opposite side edges, a front edge, and a rear edge; and
b) a bottom layer comprising foam, said bottom layer further comprising a first front edge, a second side edge, a third side edge, and a fourth rear edge, said second side edge being constructed for attachment to at least a portion of one of said opposite side edges, said third side edge being constructed for attachment to at least a portion of said other opposite side edge, wherein said front edge may be elevated relative to said first front edge to raise at least a portion of said top layer relative to said bottom layer.

2. The pet device according to claim 1 wherein said top layer and said bottom layer are enclosed within fabric material.

3. The pet device according to claim 2, said pet device further comprising at least one first support engaged to said top layer proximate to said front edge, said at least one first support constructed and arranged to elevate said front edge relative to said first front edge.

4. The pet device according to claim 3, said pet device further comprising at least one second support engaged to said top layer proximate to said rear edge, said at least one second support constructed and arranged to elevate said rear edge relative to said fourth rear edge.

5. The pet device according to claim 4, said pet device further comprising at least one first side support engaged to one of said opposite side edges and said at least one second side support engaged to said other opposite side edge.

6. The pet device according to claim 5, wherein said at least one first support is engaged to said first side support and said second side support.

7. The pet device according to claim 6, wherein said at least one second support is engaged to said first side support and said second side support.

8. The pet device according to claim 7, further comprising at least one intermediate support disposed between said at least one first support and said at least one second support.

9. The pet device according to claim 8, wherein said intermediate support is engaged to said at least one first support and said at least one second support.

10. The pet device according to claim 9, further comprising at least one traverse support extending between said at least one first side support and said at least one second side support, wherein said at least one traverse support is disposed substantially perpendicular to said at least one first side support and said at least one second side support.

11. The pet device according to claim 10, wherein said top layer is washable.

12. The pet device according to claim 11, wherein said bottom layer is washable.

13. The pet device according to claim 12, wherein said top layer is releasably separated from said fabric material.

14. The pet device according to claim 13, wherein said bottom layer is releasably separated from said fabric material.

15. The pet device according to claim 1, said pet device further comprising at least one first support and at least one second support engaged to said top layer whereby at least a portion of said top layer is elevated relative to said bottom layer.

16. The pet device according to claim 15, wherein said first support crosses said second support.
